(19) United States
(12) Patent Application Publication
(10) Pub. No.: US 2010/0088036 A1
(43) Pub. Date: Apr. 8, 2010

(54) Hair Coloring Method and Hair Coloring Selection Method

(76) Inventors: Lorri Goddard-Clark, Los Angeles, CA (US); Shari Glazer, Pacific Palisades, CA (US)

Correspondence Address: Woods Oviatt Gilman LLP, 700 Crossroads Bldg, 2 State St., Rochester, NY, 14614, US

(21) Appl. No.: 12/246,711

(22) Filed: Oct. 7, 2008

(51) Int. Cl. G06F 19/00

(52) U.S. Cl. 702/19

(57) ABSTRACT

A method for hair coloring and selecting a hair colorant formulation based on hair type that minimizes variations in resultant hair color among different users having different hair types.

### BACKGROUND OF THE INVENTION

The present invention relates to hair coloring and more particularly relates to a method for hair coloring and selecting a hair colorant formulation based on hair type.

Hair coloring involves application of a hair color (typically comprising a colorant and a developer) to a person's hair which is allowed to penetrate the hair and thereby alter the color thereof. The hair colorant is typically in liquid form and is rinsed off and neutralized following a period of time on the hair sufficient to obtain the desired hue. The longer the hair coloring is left on the hair prior to rinsing and neutralizing, the more intense the color will become.

Hair colorants are offered in a large variety of colors and hues. A picture of a model or lock of hair having that color is usually shown on the hair colorant packaging. Unfortunately, the target color shown on the package is not always the resultant hair color the person ends up with after using the hair colorant. This is because the person's natural hair color will affect the resultant color of the hair after coloring. It is understood that the term “resultant hair color” means the hair color actually achieved wherein the term “target hair color” means the hair color the person was trying to achieve. As is well understood by those using hair color, the resultant hair color does not always match the target hair color. This is because the hair shaft absorbs the hair colorant and the hair's natural hair base color necessarily combines with the hair colorant and thus helps dictate the final hair color. Thus, if the same hair colorant is used on five different people each having a different natural base hair color (or equivalent “hair type”), each person will have a different resultant hair color.

For example, a hair colorant offered in the target color “light brown” will look differently when used on a person having a blond natural hair color than on a person having a red natural hair color. This variation in resultant hair color among different users having different natural hair colors results in many people becoming disappointed and frustrated after finding the hair color they achieved (the “resultant hair color”) is not what they wanted or what the packaging showed. There therefore remains a need for a hair coloring and hair coloring selection method which minimizes the variations in resultant hair color among people having different natural hair colors yet trying to achieve the same target hair color.

### SUMMARY OF THE INVENTION

The present invention successfully addresses the above need by providing a hair coloring system and hair coloring selection method comprising the following steps:

a) identifying a person's natural base hair color by determining the person's natural color at the roots of the person's hair;

b) providing a plurality of natural hair color types and comparing the person's natural base hair color to said hair color types to find the person's natural hair color type;

c) providing a plurality of hair coloring formulations for each of a plurality of hair target colors, the plurality of hair color formulations being matched to a respective hair color type which will provide a resultant hair color which closely matches the chosen target hair color; and

d) comparing the person's natural hair color type to said hair color formulations of the desired target hair color to determine which hair color formulation will provide the desired target color.

The present method is particularly useful for a person coloring their hair at home. The hair coloring packaging includes an indication of the hair type that will achieve the target hair color for that formulation. Thus, for one particular hair target color, there may be five different formulations with each formulation indicating which hair color type will achieve the target color with that particular formulation.

The present method thus provides a hair coloring system and method for selecting the correct hair color formulation to achieve the desired target hair color.

### BRIEF DESCRIPTION OF THE DRAWING

FIG. 1 is a flow diagram showing the basic steps in carrying out the inventive method;

FIG. 2 is a schematic showing matching of different natural hair colors to a hair color type;

FIG. 3 is a schematic showing matching of hair color types to color formulations for a particular target hair color; and

FIG. 4 is a diagrammatic representation of a hair color product label according to an embodiment of the present invention.

### DETAILED DESCRIPTION OF THE PREFERRED EMBODIMENT

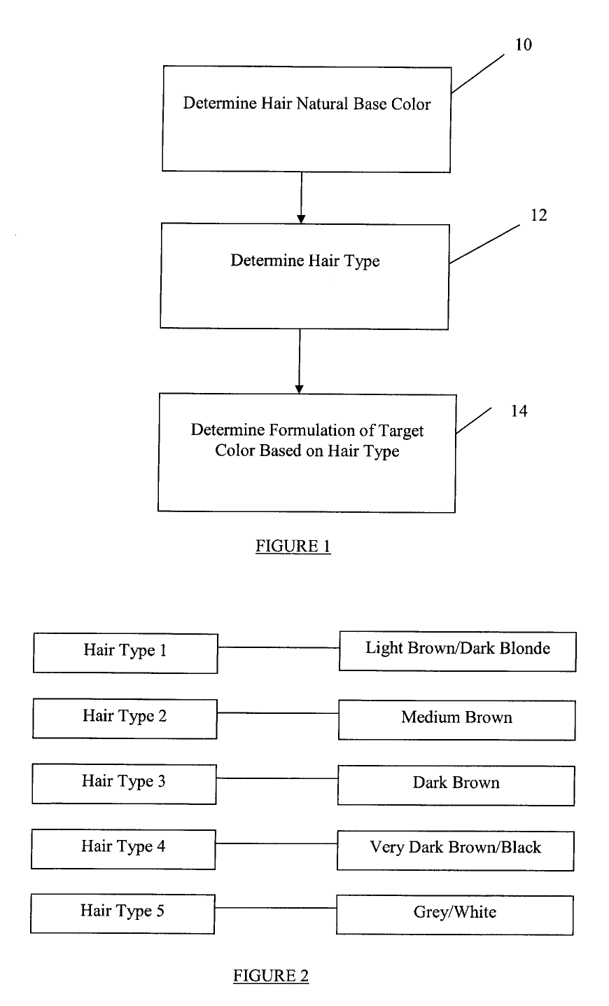

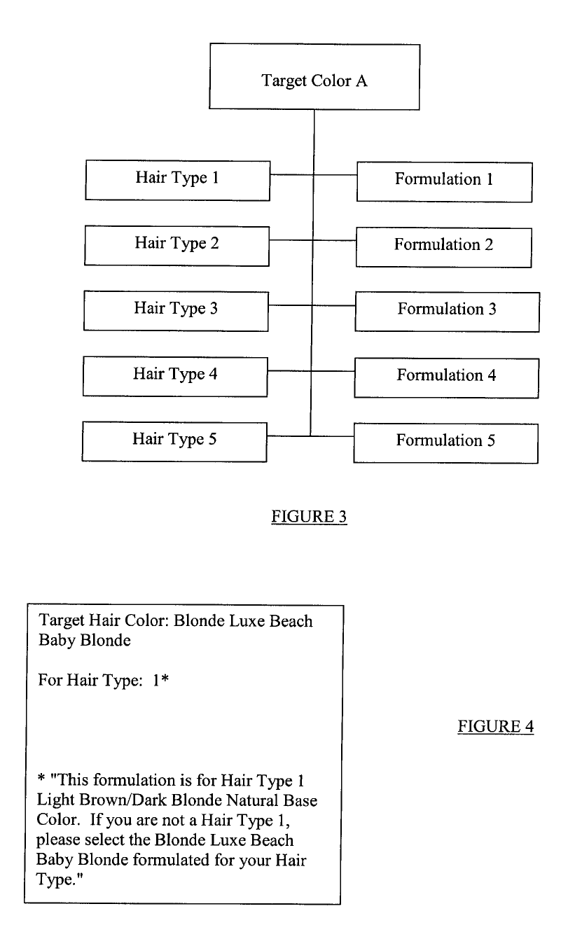

Referring to FIG. 1, the basic steps of the present method begins with a person determining their natural hair color at step 10. This is done by examining the roots of the hair at the scalp. If the person has just had their colored, they will have to wait a week or more until enough hair has grown from the roots to see the natural color.

After the natural hair color is found, the person determines what hair type their natural hair color is as indicated at box 12 in FIG. 1. A variety of natural hair colors exist and a suitable spectrum of natural hair colors may be assigned a “type”. For example, as seen in FIG. 2, each of a variety of natural hair colors is assigned a hair type as follows: Hair Type 1 corresponds to Light Brown/Dark Blonde, Hair Type 2 corresponds to Medium Brown, Hair Type 3 corresponds to Dark Brown, Hair Type 4 corresponds to Very Dark Brown/Black and Hair Type 5 corresponds Grey/White. Of course this is merely an example of natural hair colors and other natural hair colors may be described and matched to a hair type as desired.

It is understood that the term “resultant hair color” means the hair color actually achieved wherein the term “target hair color” means the hair color the person was trying to achieve. As is well understood by those using hair color, the resultant hair color does not always match the target hair color. This is because the hair shaft absorbs the hair colorant and the hair's natural hair base color necessarily combines with the hair colorant and thus helps dictate the final hair color. Thus, if the same hair colorant is used on five different people each having a different natural base hair color (or equivalent “hair type”), each person will have a different resultant hair color.

In order to minimize the variations in resultant hair color between different hair types using the same hair colorant for a particular target hair color, the present inventive method provides a different hair color formulation for each hair type. Each hair formulation is formulated to achieve the target hair color for that particular hair type. This is shown in FIG. 2 wherein five different hair types are matched to five different hair color formulations. A person who has determined their hair type thus selects a desired target color and then chooses the formulation of the target color for their particular hair type as indicated at box 14 in FIG. 1.

FIG. 4 shows a representation of an example hair color package label for a target hair color wherein the target color is Blonde Luxe—Beach Baby Blonde and the formulation is matched to Hair Type 1. The package may be further marked to ensure the person does not choose this target color if they are not hair type 1. For example, the label may be marked as seen in FIG. 4 to include a statement such as: “This formulation is for Hair Type 1—Light Brown/Dark Blonde Natural Base Color. If you are not a Hair Type 1, please select the Blonde Luxe Beach Baby Blonde formulated for your Hair Type.”

It will thus be appreciated that the present invention provides a method for hair coloring and a method for selecting a hair colorant that minimizes variations in resultant hair color among different users having different hair types. While the invention has been described with regard to preferred embodiments for carrying out the invention, it will be understood by those skilled in the art that variations may be made thereto without departing from the full spirit and scope of the invention as defined by the claims which follow.

What is claimed is:

1. A hair coloring selection method, said method comprising the steps of:
a) identifying a person's natural base hair color by determining the person's natural color at the roots of the person's hair;
b) providing a plurality of natural hair color types and comparing the person's natural base hair color to said hair color types to find the person's natural hair color type;
c) providing a plurality of hair coloring formulations for each of a plurality of hair target colors, the plurality of hair color formulations being matched to a respective hair color type which will provide a resultant hair color which closely matches the chosen target hair color; and
d) comparing the person's natural hair color type to said hair color formulations of the desired target hair color to determine which hair color formulation will provide the desired target color.
